(19) United States
(12) Patent Application Publication
(10) Pub. No.: US 2015/0161357 A1
(43) Pub. Date: Jun. 11, 2015

(54) Data Enhanced Method and System For Reducing Preventable Hospital Readmissions

(71) Applicants: Roy Scott Small, Lancaster, PA (US); Steve Brown, Harrisburg, PA (US); Ann Tweed, Lititz, PA (US)

(72) Inventors: Roy Scott Small, Lancaster, PA (US); Steve Brown, Harrisburg, PA (US); Ann Tweed, Lititz, PA (US)

(21) Appl. No.: 14/560,718

(22) Filed: Dec. 4, 2014

Related U.S. Application Data
(60) Provisional application No. 61/911,772, filed on Dec. 4, 2013.

(51) Int. Cl. G06F 19/00

(52) U.S. Cl. CPC G06F 19/3481; G06F 19/3431; G06F 19/322

(57) ABSTRACT

A social factor evaluation system for reducing hospital readmissions of discharged patients has a database module, an application module, and an analysis module. The database module stores a navigable social factors evaluation and receives social factors evaluation data inputted by a user. the analysis module performs analytics of the inputted data.

### CROSS-REFERENCE TO RELATED APPLICATIONS

This application claims the benefit of the filing date under 35 U.S.C. §119(a)-(d) of U.S. Provisional Patent Application No. 61/911,772, filed Dec. 4, 2013.

### FIELD OF THE INVENTION

The invention is generally related to a method of reducing preventable hospital readmissions, and more specifically, to a system of reducing preventable hospital readmissions.

### BACKGROUND

In the United States, about 28% of heart failure patients are readmitted within 30 days of their original hospital discharge. While some of these readmissions are unavoidable, many are preventable if the patient adheres to the prescribed treatment routine. Insurance companies and the U.S. government have estimated that the preventable readmission costs exceed nearly $12 billion annually. In an effort to minimize expenditures for preventable readmissions, the Center for Medicare and Medicaid Services (CMS) has instituted the Readmissions Reduction Program. This Program now requires hospitals to publically report their readmission rates, and may impose financial penalties on hospitals with high readmission rates. Conversely, CMS also offers financial rewards for hospitals with low readmission rates. Given this environment, hospitals are actively focusing on the development of methods to improve the quality of care while reducing preventable readmissions.

Traditionally, hospitals provide discharge instructions to a patient detailing the continuing treatment regime that the patient is to follow. The instructions generally detail such items as continuing medication, the amount and type of physical activity, and diet. Post-discharge compliance with these instructions tends to fall on the patients themselves and the patient's primary care provider. When the patient follows the discharge instructions, readmission rates are much lower than the national average. This indicates that the treatment regimens outlined in the discharge instructions are not a major source of preventable readmissions, but rather, the major source is primarily patient compliance. However, given that discharged patients are no longer under the hospital's supervision, hospitals have struggled with quickly identifying and correcting the major factors responsible for discharged patients failing to follow the discharge instructions.

Therefore, there is a need for methods that reduce preventable hospital readmissions by addressing social factors responsible for a discharged patient's non-compliance, prior to the patient's discharge.

### SUMMARY

A social factor evaluation system for reducing hospital readmissions of discharged patients has a database module, an application module, and an analysis module. The database module stores a navigable social factors evaluation and receives social factors evaluation data inputted by a user. The analysis module performs analytics of the inputted data.

### BRIEF DESCRIPTION OF THE DRAWINGS

The invention will now be described by way of example, with reference to the accompanying Figures, of which:

FIG. 1 is a simplified block diagram of a method for reducing hospital readmissions of discharged patients;

FIG. 2 is a social factors evaluation;

FIG. 3a is a first portion of a follow-up evaluation;

FIG. 3b is an a second portion of the follow-up evaluation;

FIG. 4 is a timeline diagram showing when the method for reducing hospital readmission of discharged patients is administered;

FIG. 5 is a simplified block diagram of a social factor evaluation system;

FIGS. 6a and 6b are application logic decision trees for a baseline/discharge demographics form;

FIGS. 7a and 7b are application logic decision trees for a discharge planning form;

FIGS. 8a, 8b, 8c, and 8d are application logic decision trees for an attending form;

FIGS. 9a and 9b are application logic decision trees for a follow-up form;

FIG. 10 is an application logic decision tree performed by an analysis module when a user opens a portal page in an application module;

FIG. 11 is an application logic decision tree performed by the analysis module when a user opens a work to do page in an application module; and

FIGS. 12a and 12b show a database module method for the patient readmission prevention program.

### DETAILED DESCRIPTION OF THE EMBODIMENT(S)

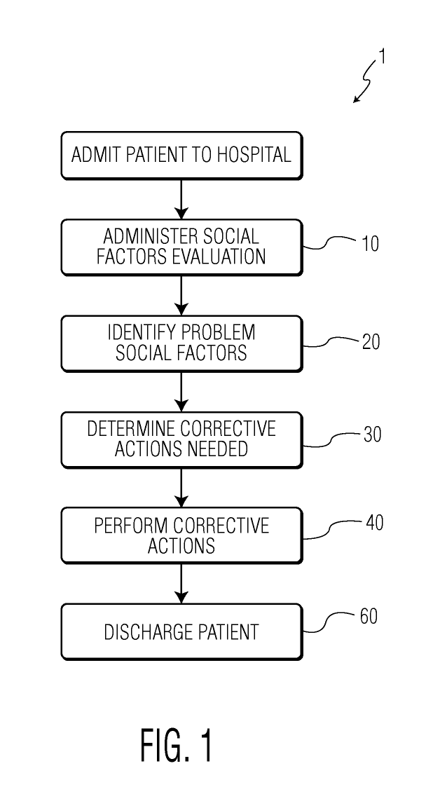

FIG. 1 is a simplified block diagram of an exemplary embodiment of a method for reducing preventable hospital readmissions 1 according to the present disclosure. An exemplary embodiment of the method includes the steps of (1) administering a social factors evaluation 10 on an admitted patient, (2) identifying problem social factors 20, (3) determining corrective actions 10b to address the identified problem social factors 30, and (4) performing the corrective actions 10b prior to the patient's discharge 40. Further embodiments may also include the additional step of generating a discharge plan 19 based on the answers given by the admitted patient in response to the social factors evaluation 10. Another exemplary embodiment includes the additional step of performing a follow-up evaluation 70 questionnaire to a discharged patient 60 to evaluate the discharged patient 60's compliance with the discharge plan 19 and/or a treatment regimen.

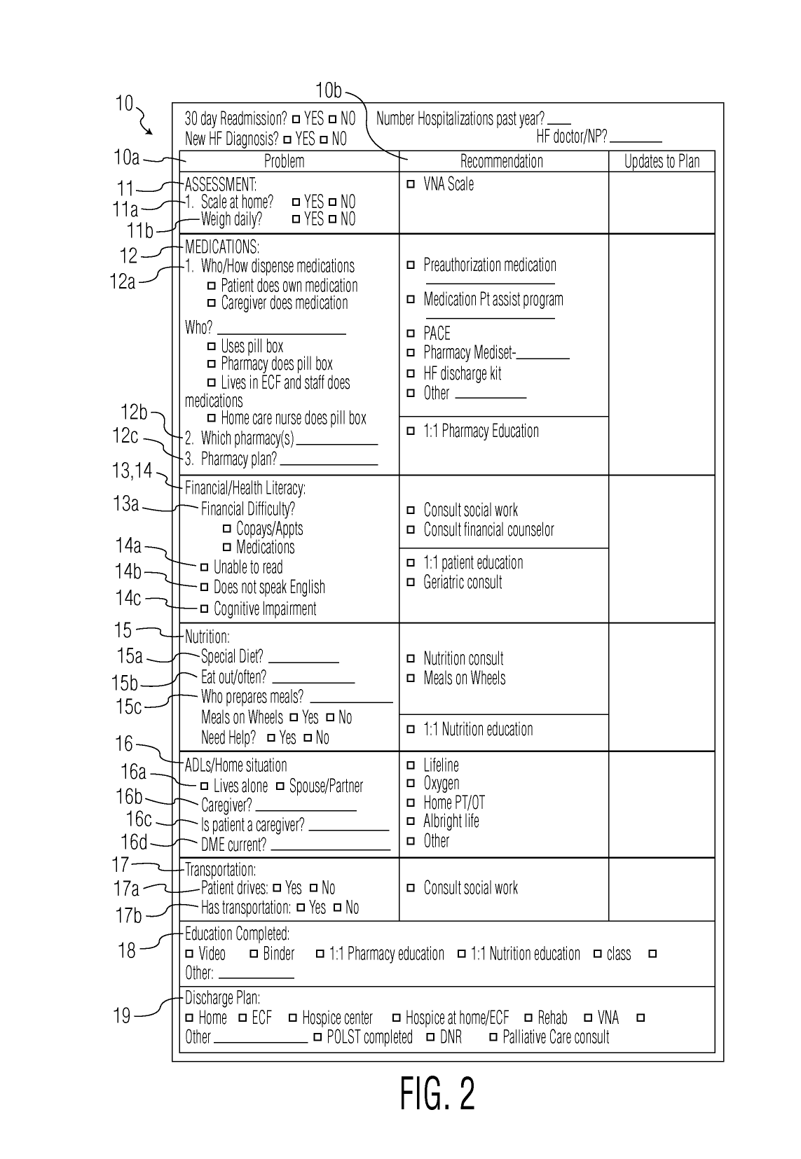

The social factors evaluation 10 includes a number of social factor questions 10 that identify social factors that may contribute to the admitted patient being unable to perform a treatment regimen outlined in their discharge plan 19. Exemplary embodiments of the social factors evaluation 10, shown in FIG. 2, include but are not limited to, social factor questions 10 such as the patient's access to physical assessment devices 11, medication acquisition and administration 12, financial literacy 13, health literacy 14, nutrition 15, activities of daily living (“ADL”) and home situation 16, access to transportation 17, or a combination thereof. One of ordinary skill in the art would recognize that this is not an exhaustive list, and that there are other social factors which may also be included in a social factors evaluation 10.

The social factor question 10 on physical assessment devices 11 includes asking the admitted patient if they have access to a scale at home 11a and if they would be able to weigh themselves daily 11b. If the patient does have access to a scale at home and is able to weigh themselves daily, then no problem social factor 10a is identified. If the patient does not have access to a scale at home, then a problem social factor 10a has been identified and corrective actions 10b are needed.

The corrective action 10b is to provide the admitted patient with a scale to take home, prior to the patient's discharge 60.

The social factor question 10 on medication acquisition and administration 12 includes a number of sub-questions, including (1) who and how medications are dispensed 12a, (2) which pharmacy will be used to provide the medications 12b, and (3) whether there is a pharmacy plan in place to provide pharmacy education to the patient after hospital discharge 12c?

The “Who” and “How” medications 12a are dispensed involve a further series of sub-questions, including whether the patient is solely responsible for taking their own medication, if a caregiver is responsible for ensuring the patient takes their medication, whether the patient uses a pill box, if yes, whether the patient or the pharmacy fills the pill box, whether the patient lives in an extended care facility, whether the staff is responsible for the acquisition and administration of the patient's medication, and whether a home care nurse does the pill box.

If a caregiver is identified as being responsible for ensuring that the patient takes their medication, that the patient lives in an extended care facility, that the staff is responsible for the acquisition and administration of the patient's medication, that the pharmacy fills the pill box, or a home care nurse fills the pill box, then no problem social factor 10a has been identified. If the patient is solely responsible for taking their own medication, does not use a pill box, or the patient fills the pill box themselves, problem social factor 10 as have been identified and corrective actions 10b are needed prior to the patient's discharge.

The corrective actions 10b may include contacting the pharmacy that will supply the discharged patient's 60 medication to obtain insurance preauthorization of the prescribed medication or enrolling the patient in a medication assist program to ensure the patient first has access to the prescribed medications. Other corrective actions 10b for Medicare or Medicaid patients may include enrollment in assistance programs such as the Program of All-Inclusive Care for the Elderly (PACE) to provide a caregiver who is responsible for ensuring that the patient takes the prescribed medications or at least fills the pill box. If the patient does not use a pill box or fills the pill box themselves, corrective actions 10b include providing the patient with a pill box and training on how to use the pill box correctly, or contacting the pharmacy that will supply the discharged patient's 60 medication and enrolling the patient in a pharmacy mediset program. A mediset program is a medication management system run by the pharmacy whereby the patient's medication is dispensed in prefilled weekly pill boxes.

The social factor questions 10 on financial literacy 13 include (1) whether the admitted patient will have the financial ability to pay for insurance co-payments associated with follow-up visits to their primary care provider 13a, and (2) whether the admitted patient will have the financial ability to pay for the prescribed medications or insurance medication co-payments 13b. If the admitted patient indicates that any of these financial difficulties apply, a problem social factor 10a has been identified and corrective actions 10b are needed prior to the patient's discharge.

Corrective actions 10b may include patient consultations with a social worker, patient consultations with a financial counselor, or enrolling the admitted patient in a medication assistance program.

The social factor questions 10 on health literacy 14 include (1) whether the admitted patient is literate and can read instructions 14a, (2) whether the admitted patient speaks and reads English 14b, and (3) whether the admitted patient has a cognitive impairment that would affect comprehension of the discharge plan 19 and treatment regimen 14c. If the patient is unable to read instructions, does not speak English, or has a cognitive impairment that affects comprehension, then a problem social factor 10a has been identified and corrective actions 10b are need prior to the patient's discharge.

Corrective actions 10b may include one on one patient education to educated the admitted patient on their prescribed discharge plan and treatment regimen. Corrective actions 10b for patients with cognitive impairments may include consultations with geriatric counselors and education of the admitted patient's caregivers.

The social factor questions 10 on Nutrition 15 include (1) whether the admitted patient requires a special or restricted diet 15a, (2) how often the admitted patient eats out 15b, (3) who prepares the admitted patient's meals when at home 15c. If the admitted patient requires a special or restricted diet, eats out often, or customarily prepares their own meals, then a problem social factor 10a has been identified and corrective actions 10b are needed prior to the patient's discharge.

Corrective action 10b may include a nutritional consultation to educate the admitted patient on how to follow a special or restricted diet. If the admitted patient customarily prepares their own meals or eats out often, corrective action 10b may include contacting food assistance programs such as Meals on Wheels to assist the patient after discharge. Additionally corrective actions 10b may include arranging a caretaker to provide help.

The social factor questions 10 on the admitted patient's activities of daily living and home situation 16 include (1) whether the admitted patient lives alone or with a Spouse/Partner 16a, (2) whether the spouse/partner is the caregiver to the patient 16b, (3) whether the admitted patient is a caregiver to the spouse/partner 16c, and (4) whether the durable medical equipment in the patient's home is current 16d. If the admitted patient lives alone or the durable medical equipment is not current, then a problem social factor 10a has been identified and corrective actions 10b are needed prior to the patient's discharge.

Corrective actions 10b may include enrolling the patient in a medical alert service such as Lifeline, arranging for temporary care in an assisted living facility, or arranging for home visits by physical and occupational therapists. Other corrective actions 10b may include upgrading the patient's durable medical equipment and scheduling regular deliveries of consumables such as oxygen.

The social factor questions 10 on the admitted patient's access to transportation 17 include (1) whether the admitted patient is able to drive 17a, or (2) whether the admitted patient has a means of transportation that permits the patient to follow the discharge plan and treatment regimen 17b. If the admitted patient is unable to drive, or does not have access to an alternative mode of transportation, a problem social factor 10a has been identified and corrective actions 10b are needed prior to the patient's discharge.

Corrective actions 10b include a consultation with a social worker to determine a transportation mode which will assist the patient in following the discharge plan and treatment regimen.

The exemplary social factors evaluation 10 shown in FIG. 2 also includes an Education Completed 18 and a Discharge Plan 19 sections. The Education Completed 18 section provides a list of educational tools that may be used to educate the patient on the above identified problem social factors 10a. In the exemplary form, specific educational material used is tracked and recorded. The education material includes videos, binders, 1:1 pharmacy education, 1:1 nutritional education, classes, and an options entry where other educational material may be recorded. The Discharge Plan 19 section provides a list of potential discharge options, and the actual discharge option that will be followed is tracked and recorded. Potential discharge options include home, extended care facility (“ECF”), Hospice center, hospice at home/ECF, rehab, visiting nurse association (“VNA”), and a other entry where other discharge options may be recorded. The Discharge Plan 19 section also tracts whether physician's orders for life sustaining treatment (“POLST”) has been completed, if the patient is do not resuscitate (“DNR”), and if a Palliative Care consult has been completed.

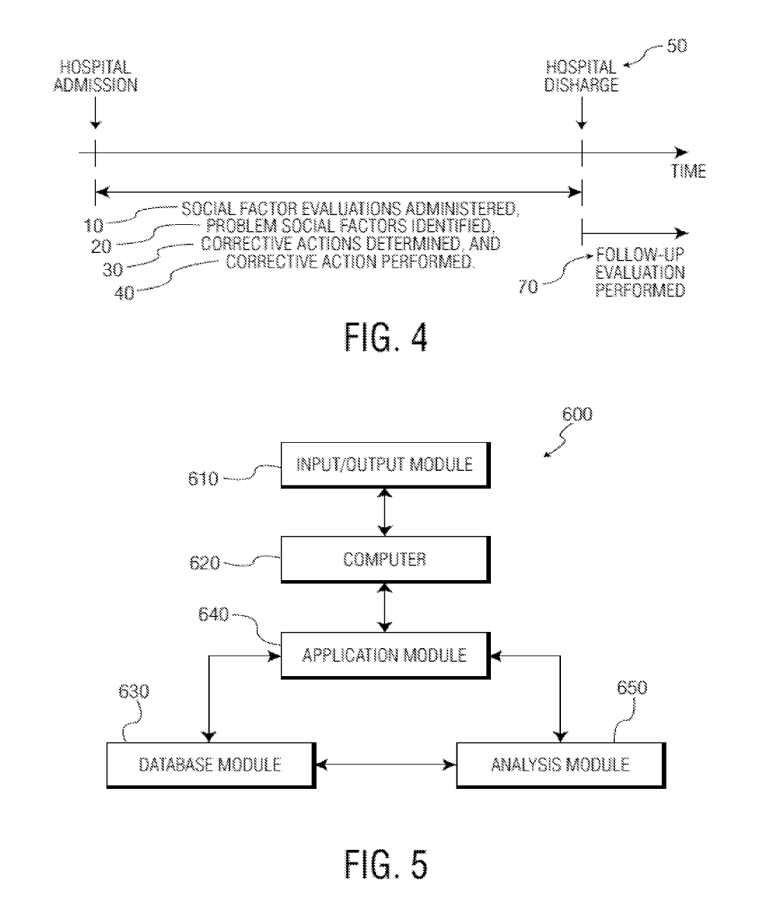

FIG. 4 is an exemplary timeline diagram showing when the disclosed method for reducing hospital readmission 1 of discharged patients 60 is administered to an admitted patient. The exemplary timeline diagram illustrates when the method 1 is applied to a patient. For example, an average heart failure patient is admitted into a hospital and is discharged 5-7 days later. In an exemplary embodiment, the patient is assessed through the method 1 starting at the time of admission to the hospital. In an exemplary embodiment, during the time the patient is admitted, the patient is assessed through the method 1 at least one time prior to the patient's discharge 60 from the hospital. In another exemplary embodiment, the patient is assessed through the method 1 at least two times prior to the patient's discharge 60 from the hospital. In yet another exemplary embodiment, the patient is assessed through the method 1 at least three times prior to the patient's discharge 60 from the hospital.

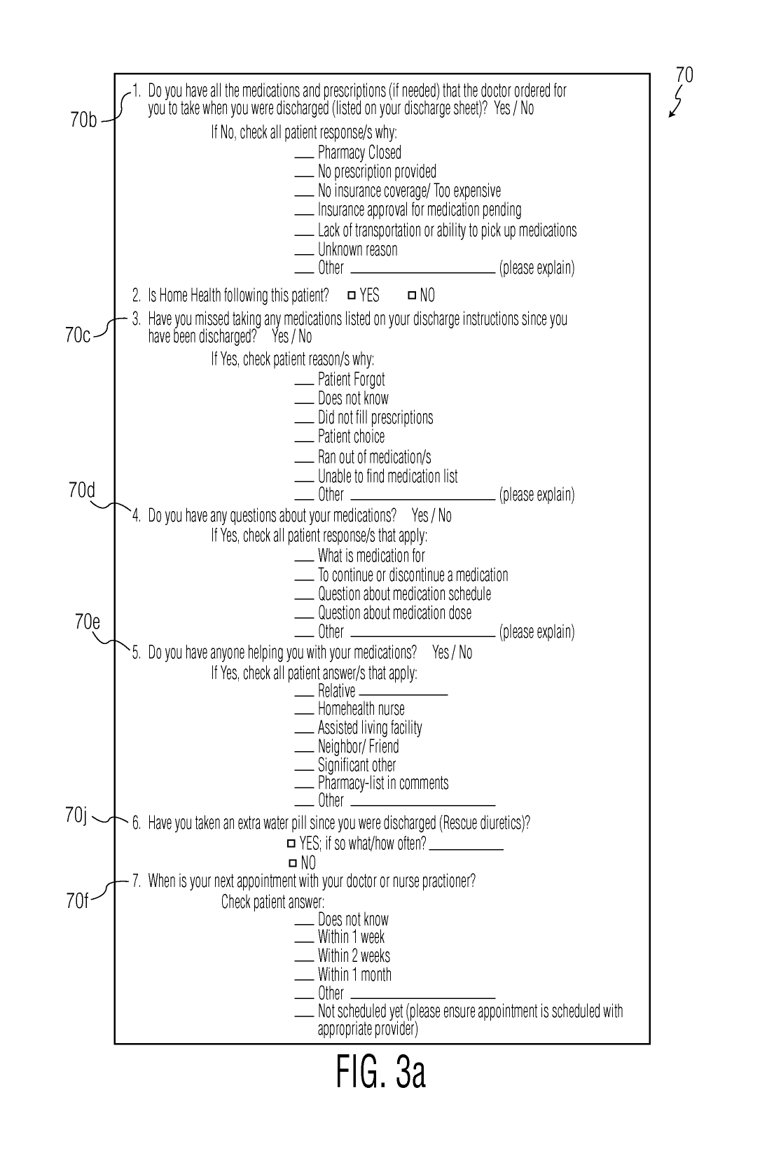

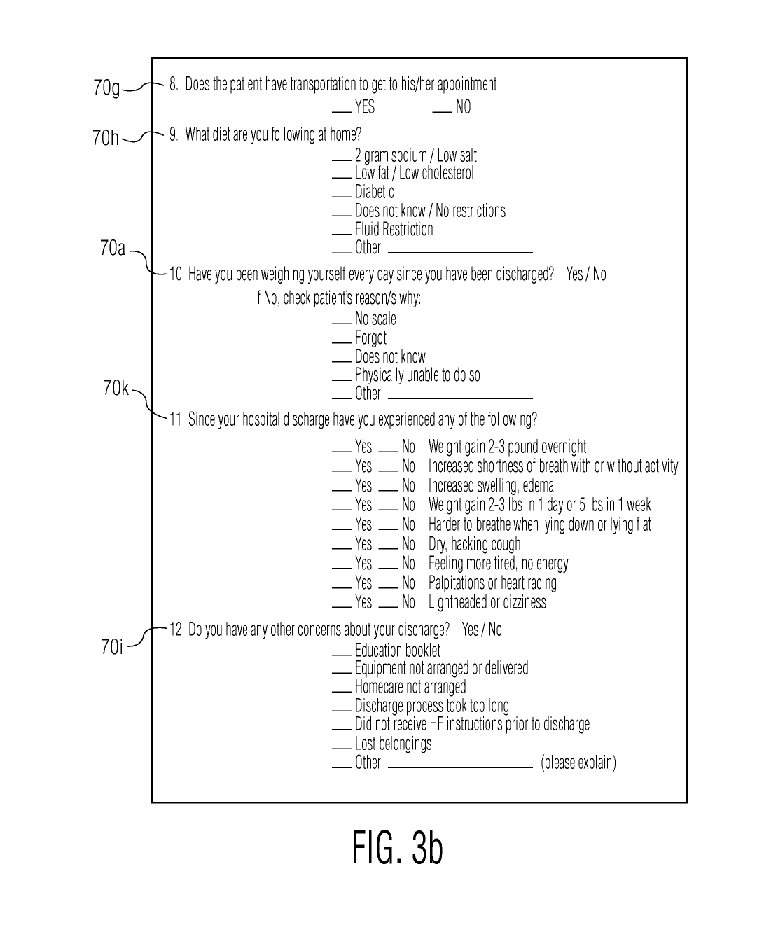

In another exemplary embodiment shown in FIG. 3, the method 1 includes the additional step of performing a follow-up evaluation 70 of a discharged patient 60 to assess the level of the discharged patient's 60 compliance with the discharge plan 19 and/or a treatment regimen. The follow-up evaluation 70 may be given to the discharged patient 60 through a variety of communication modes, such as a telephone call, a home visit, a patient visit back to the hospital, at the patient's primary care physician's office, or any other available communication mode.

The follow-up evaluation 70 is conducted after hospital discharge 60 as shown in FIG. 4 and assesses whether the corrective actions 10b taken prior to the patient's discharge 60 from the hospital were effective, or if additional corrective actions 10b are still necessary. As shown in FIG. 3, the follow-up evaluation 70 is an expanded version of the social factors evaluation 10 given to the patient when the patient was admitted to the hospital. The follow-up evaluation 70 is an expanded version because of the inclusion of questions related to the discharged patient's 60 compliance with the discharge plan 19 and treatment regime. The follow-up evaluation 70 continues to evaluate and identify problem social factors 10a; determine corrective actions 10b to address the identified problem social factors 10a; and to perform corrective actions 10b to assist a discharged patient 60 in following the discharge plan 19 and treatment regimen.

An exemplary embodiment of the follow-up evaluation 70 includes questions related to the discharged patient's 60 access to physical assessment devices 11, such as a scale. The follow-up evaluation 70 further assesses whether the discharged patient 60 is following the discharge plan 19 and treatment regimen. An exemplary question may include asking the discharged patient 60 if they have being weighing themselves every day since they have been discharged 70a. If the discharged patient 60 has been weighing themselves daily, then no problem social factor 10a is present, and no corrective actions 10b are needed.

If the discharged patient 60 has not been weighing themselves daily, then a problem social factor 10a has been identified, and a series of sub-questions are asked to determine what corrective actions 10b are needed to address the identified problem social factor 10a. This sub-question includes determining the patient's reason why, such as they do not have a scale, they forgot, they did not know, they are physically unable to do so, or any other reason. Corrective actions 10b can then be performed, such as providing the discharged patient 60 with a scale, educating the discharged patient 60, or arranging assistance for the discharged patient 60.

An exemplary embodiment of the follow-up evaluation 70 includes questions related to the discharged patient's 60 medication acquisition and administration 12. The follow-up evaluation 70 further assesses whether the discharged patient 60 is following the treatment regimen relating to the medication 70b. An exemplary question may include asking the discharged patient 60 if they have all the medications and prescriptions that the doctor ordered when the patient was discharged. If the discharged patient 60 does have all the medications and prescriptions, then no problem social factor 10a is present, and no corrective action 10b is needed.

If the discharged patient 60 does not have the medications and prescriptions, then a problem social factor 10a has been identified, and a series of sub-questions are asked to determine what corrective actions 10b are needed to address the identified problem social factor 10a. These sub-questions may include determining the patient's reason why, such as the pharmacy closed, no prescription was provided, no insurance coverage or too expensive, insurance approval for medication pending, a lack of transportation or ability to pick up medications, or any other reason. Corrective actions 10b such as those discussed above for the social factors evaluation 10 can then be performed.

If the discharged patient 60 has affirmatively answered that they have access to the medication and prescriptions, an exemplary question may include asking the discharged patient 60 if they have missed taking any of the medications listed in the discharge plan 19 and treatment regimen. If the discharged patient 60 answers that they have not missed taking any of the medications, then no problem social factor 10a is present, and no corrective action 10b is needed.

If the discharged patient 60 has missed taking any medications, then a problem social factor 10a has been identified, and a series of sub-questions are asked to determine what corrective actions 10b are needed to address the identified problem social factor 10a. These sub-questions may include determining the patient's reason why they have missed, such as the patient forgot, does not know, did not fill the prescriptions, chose not to take them, ran out of the medication, lost the medication, or any other reason. Corrective actions 10b such as those discussed above for the social factors evaluation 10 can then be performed. Additional corrective actions 10b may also include asking the discharged patient 60 if they have any questions about the medications 70d, such as what the medication is for, whether to continue or discontinue a medication, the medication schedule, the medication dose, or any other questions, followed by answering the patient's questions.

Another exemplary embodiment of the follow-up evaluation 70 combines questions related to the discharged patient's 60 medication administration 12, nutrition 15, and activities of daily living and home situation 16. These questions include whether the discharged patient 60 has assistance in taking their medications 70e. If the discharged patient 60 does not have assistance and has indicated above that they do not have the medication or prescriptions, or have missed taking medication, a problem social factor 10a has been identified and corrective actions 10b are needed to address the identified problem social factor 10a. Corrective actions 10b such as those discussed above for the social factors evaluation 10 can then be performed.

If the discharged patient 60 does have assistance, has the medications, and has not missed taking the medications, then no problem social factor 10a has been identified, and no corrective action 10b is required.

A further exemplary question includes whether the patient is following the discharge plan 19 and treatment regimen's dietary plan 15, such as a low sodium diet, low fat/cholesterol diet, a diabetic diet, whether the patient is aware of a special dietary plan, any fluid restrictions, or any other dietary considerations 70h. If the discharged patient 60 indicates problems following the dietary plan, a problem social factor 10a has been identified, and corrective actions 10b are needed to address the identified problem social factors 10a. Corrective actions 10b such as those discussed above for the social factors evaluation 10 can then be performed.

In another exemplary embodiment of the follow-up evaluation 70 questions related to the discharged patient's 60 access to transportation 17 and the patient's primary care physician are included. These questions include whether the discharged patient 60 has a future appointment with their primary care physician 70f, and if the discharged patient 60 has transportation to get to the appointment 70g. If the discharged patient 60 has an appointment and transportation, then no problem social factor 10a has been identified, and no corrective action 10b is needed.

In yet another exemplary embodiment of the follow up evaluation 70, the effectiveness of the corrective measures 10b performed while the patient was admitted to the hospital is evaluated 70i. Exemplary questions include whether the discharged patient 60 understands any educational booklets provided, if durable medical equipment was arranged and delivered, if homecare was not arranged, if the discharge process duration was excessive, if discharge instructions were provided prior to discharge, if all of the patient's belongings were returned, or if any other corrective measure was successfully performed.

In the exemplary embodiment of FIG. 3, a discharged heart failure patient 60 may optionally be assessed for the use of additional water pills since they were discharged 70j.

In another exemplary embodiment, the above described method for reducing preventable hospital readmissions 1 includes a social factor evaluation system 600 capable of displaying a digital form of the social factor questions 10 used in the social factor evaluation, and being adapted to receive data inputs in the form of answers to the social factor questions 10. See FIG. 5. Specifically, the social factor evaluation system 600 includes an input output module 610, a processor 620 connected to the input output module 610, a local or remote database module 630 collecting and storing data entered in the input output module 610 by a user, an application module 640 displaying on the input output module 610 and having a user selectable menu of potential problem social factors 10a, and an analysis module 650 providing analytics of the data entered by the user into the database module 630 to identify problem social factors 10a, and providing instructions to the application module 640 to present the user a list of corrective actions 10b that address the identified problem social factors 10a.

The input output module 610 provides a visual display of the information and content provided from the other modules 630,640,650.

The social factor evaluation system 600 includes a processor 620 connected to the input output module 610. Exemplary embodiments of the processor 620 include, but are not limited to, laptop computers, tablet computers, smartphones and other mobile devices, desktop computers, servers or any other processor system connectable to an input output module 610.

The local or remote database module 630 is connected to the processor 620 collects, stores, and maintains data for use by the other modules in the social factor evaluation system 600. Exemplary embodiments of the database module 630 include local memory storage devices within the processor 620, or may be a remote, cloud-based memory storage device connected to the processor 620. Transmission of data from the processor 620 to the database module 630 may be accomplished wirelessly, or through direct, physical connections such as the internet, LAN, WAN, or other common transmission modes.

The application module 640 is connected to the processor 620 and displays on the input output module 610 a digital form of the social factor evaluation 10. The application module 640 presents a list of the above identified social factors on the input output module 610. A user performing the social factor evaluation 10 can record the admitted patient's responses to the social factors questions and sub-questions by inputting the data into the input output module 610. The application module 640 is connected to the processor 620, database module 630, and analysis module 650.

The user inputted data is stored on the database module 630 and is analyzed by the analysis module 650 to identify problem social factors 10a. When problem social factors 10a are identified, the analysis module 650 determines specific corrective actions 10b linked to each identified problem social factor 10a. In an exemplary embodiment, the analysis module 650 performs an if/then analysis to link problem social factors 10a with appropriate corrective actions 10b. Examples of problem social factors 10a and appropriate corrective actions 10b are described above in the social factor evaluation 10 and follow-up evaluation. The analysis module 650 instructs the application module 640 to present the user a list of corrective actions 10b that address the identified problem social factors 10a. The user may then input corrective actions 10b performed prior to the patient's discharge 60 from the hospital. The inputted corrective actions 10b are stored on the database module 630 for future reference or follow-up.

In an exemplary embodiment, the social factor evaluation system 600 includes the follow-up evaluation 70 discussed above.

In an exemplary embodiment, the social factor evaluation system 600 is integrated into an electronic medical record system having the patient's clinical data to form a predictive patient readmission system 200. In an exemplary embodiment, integration of the social factors evaluation system 600 with the electronic medical records allows predictions to be calculated to determine patients having a high probability of readmission, based on the combination of the patient's clinical data and the identified problem social factors 10a. Identifying patients with a higher probability of readmission allows the hospital to create a discharge plan 19 and treatment regimen that is tailored specifically to the needs of that individual patient.

In an exemplary embodiment, selected clinical data for the admitted patient is combined with the social factor evaluation system 600 to form a predictive patient readmission system 200. The predictive patient readmission system 200 predicts which patients have a higher than average probability of being readmitted, allowing the hospital to create a discharge plan 19 and treatment regimen tailored specifically to the needs of that individual patient.

In the following description below for the exemplary predictive patient readmission system 200, the system is described for a patient having congestive heart failure. However, one of ordinary skill in the art would appreciate and recognize that the described predictive patient readmission system 200 may be used broadly in a variety of clinical therapeutic areas, and is not limited to congestive heart failure.

The predictive patient readmission system 200 includes the input output module 610, the processor 620 connected to the input output module 610, the local or remote database module collecting and storing data entered in the input output module 610 by a user; the application module displaying on the input output module 610 and having the user selectable menu of potential problem social factors 10a and selected clinical data input fields; the analysis module providing analytics of the data entered by the user and identifying problem social factors 10a and problem clinical data; and a reporting module communicating a list of corrective actions to address the identified problem social factors 10a and problem clinical data.

The input output module 610, the processor 620, the database module 630, the application module 640, and the analysis module 650 are same as those discussed above for the social factor evaluation system 600, and those descriptions are incorporated by reference for the predictive patient readmission system 200.

The application module 640 is displayed on the input output module 610 and provides a user engageable interface on the input output module 610. The application module 640 presents a user with a series of potential problem social factors 10a and potential problem clinic data on the input output module 610. A user using the predictive patient readmission system 200 can record the patient's responses to social factors questions 10 and selected clinical data by inputting the data into the input output module 610.

The application module 640 includes a series of database-linked forms administered to a patient, both during the patient's admission in the hospital, and after the patient's discharge. In an exemplary embodiment, the application module 640 includes a baseline/discharge demographics form 100, a discharge planning form 200, an attending form 300, and at least one follow-up form 400.

An exemplary baseline/discharge demographics form 100 (“baseline form”) is administered upon admission to the hospital. The baseline form 100 includes Patient Demographics, Baseline Data, and Patient Objective Data sections.

Under Patient Demographics, the patient's medical record number (MRN), admission date, name, date of birth, and gender are recorded by a user.

The Baseline Data section includes the sub-sections of (1) Entry Criteria for a predictive patient readmission program, (2) the patient's starting height, weight, and body mass index (BMI), (3) Etiology of heart failure, (4) Co-morbidities, and (5) Cardiac Parameters. For the Entry Criteria, the user is asked to input whether the patient meets the entry criteria and the date the patient was evaluated. If the patient does not meet the criteria, the user can choose from a list of options, including: hospice or end-stage, eGFR <20 or impending dialysis, schedules MCS, OHS, or transplant, outpatient inotropes, and first hospitalization for heart failure. Under the Etiology, the user selects from a list of options including Ischemic cardiomyopathy, non-ischemic cardiomyopathy, valvular, or other. Under Co-Morbidities, the user selects from a list including: HTN, COPD, CKD eGFR >20 and less than 60, DM, history of non-compliance, neurologic impairment, and sleep disordered breathing. Under Cardiac Parameters, the user answers a series of sub-questions and answers including: EF (</=25% or 26-40%), Permanent atrial fibrillation (Yes or No), implantable device (Pacemaker, CRT-D, CRT-P and ICD), and Severe valvular disease (Mitral regurgitation, Aortic insufficiency, Aortic Stenosis, and Tricuspid regurgitation). In another exemplary embodiment, under Cardiac Parameters, the series of sub-questions and answers include diastolic questions were EF is normal.

Under the Patient Objective Data Section, a list of clinically relevant patient data is recorded by a user at the time of the patient's admission and at the time of patient's discharge from the hospital. The user is provided two fields to input data, a first field corresponding to the patient's data at the time of admission, and a second field corresponding to the patient's data at the time of discharge. The Patient Objective Data Section includes at least one of the following clinically relevant patient data: weight, I/O, hemoglobin levels, sodium levels, potassium levels, BUN levels, Creatinine levels, BNP levels, Chest X-ray congestion presence (Yes or NO), and Impedance.

An exemplary discharge planning form 200 is administered while the patient is admitted to the hospital. The discharge planning form 200 includes Discharge Planning, Adverse Outcome Prediction (NP) and Discharge Risk Factors sections.

In an exemplary embodiment, the Discharge Planning section includes the social factors evaluation 10 questions and answers discussed above. In another exemplary embodiment the Discharge Planning section includes the subsections: Discharge Needs, Patient Education, Recommendation, and Follow-up Appointment.

Under Discharge Needs and Patient Education subsections, the user is presented with the question of whether the following needs are met for the patient, with three input fields:“Yes”, “No”, or “not available”. The following needs are listed as: placement arranged, caregiver identified, medication script review, medication payment discussed, transportation arranged, plans for meals, home health arranged, follow-up appointment scheduled, follow-up labs scheduled, given information on congestive heart failure, discussed diet and exercise, received medication counseling, planned weight monitoring, and counseling on smoking cessation? Under the Recommendation subsection, the user inputs a yes or no answer to whether the patient will be discharged because all of the criteria under Discharge Needs and Patient Education have been met. If all of the criteria under Discharge Needs and Patient Education have not been met, the user inputs a yes or no as to whether the unmet criteria will be addressed prior to discharge.

The Follow-up Appointment subsection includes fields for the user to enter the date of the follow-up appointment, the provider, and a field that asks for a reason to be entered if no follow-up appointment is scheduled.

In an exemplary embodiment, the Adverse Outcome Prediction section includes the question: compared to other heart failure patients with reduced EF you have discharged in the last six months, what do you think is this patient's risk of readmission in the next 30 days, in tertiles? The user is provided with three options to choose from: (1) highest tertiel (most risk), (2) middle tertile, and (3) lowest tertile (least risk). In another exemplary embodiment, the Adverse Outcome Prediction section includes the question: compared to other heart failure patients with normal EF you have discharged in the last six months, what do you think is this patient's risk of readmission in the next 30 days, in tertiles? The user is provided with three options to choose from: (1) highest tertiel (most risk), (2) middle tertile, and (3) lowest tertile (least risk). In yet another exemplary embodiment, the Adverse Outcome Prediction section includes the question: compared to other heart failure patients with normal EF or reduced EF you have discharged in the last six months, what do you think is this patient's risk of readmission in the next 30 days, in tertiles? The user is provided with three options to choose from: (1) highest tertiel (most risk), (2) middle tertile, and (3) lowest tertile (least risk).

In an exemplary embodiment, the Discharge Risk Factors section includes the subsections: Home environment, Co-morbidities, and Heart Failure Severity.

Under the Home environment subsection, the user is presented with a series of questions with three input field: Yes, No, and Unknown. The series of questions includes: history of noncompliance, cognitive limitations, lack of family support in home, limited financial resources, no transportation available for follow-up, and limited understanding of English. The Home environment additionally includes a field where the user is asked to rate the severity of the home environment as: 1. most risk, 2. moderate risk, or 3. least risk.

Under the Co-morbidities subsection, the user is presented with a series of questions with three input field: Yes, No, and Unknown. The series of questions include: history of depression, history of symptomatic cerebrovascular disease, known hospitalization in the last six months for non-cardiac diagnosis, needs help with ADL, and Active solid and hematologic malignancy. Additionally, under the Co-morbidities subsection, the user is presented with a second series of questions with two input field: Yes, and No. The second series of questions include: Age >70, Anemia (HGb<10), Malnutrition (Albumin <3.5), Renal disease (eGFR <60) and pulmonary dx on daily meds. The Co-morbidities subsection further includes the question: Rate risk of readmission, where the user is asked to rate the likelihood of the co-morbidities contributing to the risk of readmission. The user is provided three optional fields to choose from: (1) not likely, (2) moderately likely, and (3) highly likely.

Under the Heart Failure Severity subsection, the user assigns a point value of 1 or 2 points to determine a Total Heart Failure Severity Score, where the higher the Total, the more severe the heart failure. The user inputs 1 point for each of the following: congestion, not on Acel/ARB, and not on B-Blocker. The user assigns 1 point if SBP is >90, if BNP or NT-proBNP is BNP >500 or NT-proBNP >2000, if BUN is 40-80, if Na is 130-133 meg/L, if Furosemide dose is 100-240 mg/day, if LOS is 5-10 days, and if patient has be hospitalized once for heart failure in past year.

The user assigns 2 points if SBP is <90, if BNP or NT-proBNP is BNP >1300 or NT-proBNP >4000, if BUN is >80, if Na is <130 meg/L, if Furosemide dose is >240 mg/day, if LOS is >10 days, and if patient has be hospitalized 2 or more times for heart failure in past year.

An exemplary attending form 300 is administered during the time the patient is admitted to the hospital. The attending form 300 includes a Medical Stability, Neuro-hormonal Therapy, Oral Regimen Stability, Adverse Outcome Prediction (MD), Complications and Patient Objective Data sections.

An exemplary embodiment of the Medical Stability section includes fields for the user to record patient congestion and de-congestion data such as JVP, Edema, Cardiac Orthopnea and Rales. Based on the answers in the field, the user is asked if the patient will be diuresed further. If the user records that the patient will not be diurested further, the user is prompted to indicate the reasons, and is provided a list to choose from: renal dysfunction, hypotension, low albumin, patient resistance, or Other. The Medical Stability section may also include field for the user to record with the patient exhibits poor perfusion or adequate perfusion relating to SPB, postural symptoms, and worsening creatinine Based on the answers entered for perfusion, the user is asked if the patient's oral therapy will be changing. If the user records that the patient's oral therapy will not be changing, the user is prompted to indicate the reasons, and is provided a list to choose from: unresponsive to medication changes, autonomic neuropathy (not HF) is cause of postural symptoms, or Other.

An exemplary embodiment of the Neuro-Hormonal Therapy section includes fields for the user to record the Home Therapy being followed at the time of patient admission and the Current Therapy to be followed at the time of patient discharge. The user enters and records the relevant therapy category and dose of any beta blockers, ACEi inhibitors, ARB, Alternative heart failure therapy, and diuretics the patient took during Home Therapy, and Current Therapy at the time of the patient's discharge. Based on the answers entered, the user is asked if the patient will be discharged on an equivalent or greater dose than the patient was on at the time of admission. If the user records that the patient is not being discharged on at least an equivalent dose, the user is prompted to indicate the reasons, such as whether the discharge plan 19 increases dose prior to discharge or Other, or because of B-Blocker side effects such as hypotension, bradycardia, worsening pulmonary status, inadequate dieresis, or inotropic therapy, or because of ACEi/ARB side effects of hyperkalemia, worsening renal function, hypotension, cough, or patient refusal, or because of diuretic side effects such as worsening renal dysfunction or hypotension.

An exemplary embodiment of the Oral Regimen Stability section includes fields for Stability criteria, such as whether an admitted patient is >/=36 hrs off IV intropic or vasodilator Rx, is Cr stable (</=0.2 increase in past 24 hrs), >/=hrs stable fluid status on oral diuretics, BUN stable (<10 increase in past 24 hrs), no ACEi/B-Blocker, hydralazine does held for low BP or HR in past 24 hours, and 3.4<K+<5.2. Based on the answers entered, the user is asked if all the stability criteria has not been met, will the patient be stabilized for 24 hours? If not, the user is prompted to provide the reasons for not being stabilized, such as patient resistance to further hospitalization, expectations of successful stabilization as an outpatient, perceived futility for frequent flier, or Other. If all of the stability criteria has been met, the user is asked if the patient will be discharged. If not, the user is prompted to provide the reasons for not discharging, such as the patient has not received the necessary patient education, the patient is awaiting placement, unresolved social issues, or Other.

In an exemplary embodiment, the Adverse Outcome Prediction section includes the question: compared to other heart failure patients with reduced EF you have discharged in the last six months, what do you think is this patient's risk of readmission in the next 30 days, in tertiles? The user is provided with three options to choose from: (1) highest tertiel (most risk), (2) middle tertile, and (3) lowest tertile (least risk). In another exemplary embodiment, the Adverse Outcome Prediction section includes the question: compared to other heart failure patients with normal EF you have discharged in the last six months, what do you think is this patient's risk of readmission in the next 30 days, in tertiles? The user is provided with three options to choose from: (1) highest tertiel (most risk), (2) middle tertile, and (3) lowest tertile (least risk). In yet another an exemplary embodiment, the Adverse Outcome Prediction section includes the question: compared to other heart failure patients with normal EF or reduced EF you have discharged in the last six months, what do you think is this patient's risk of readmission in the next 30 days, in tertiles? The user is provided with three options to choose from: (1) highest tertiel (most risk), (2) middle tertile, and (3) lowest tertile (least risk).

In an exemplary embodiment of the Complications section, the user is asked if there are other problems other than heart failure that may have delayed effective therapy or added hospital days. The user is provided three categories: CV non-heart failure, non-cardiac, and social. Under the CV non-heart failure category, the user is provided with a list of options to select from, such as atrial arrhythmia, ventricular arrhythmia, CAD, PVD, and Procedure. Under the non-cardiac category, the user is provided with a list of options to select from, such as pulmonary, GI, neuro, infection, renal, skin, and Other.

In an exemplary embodiment of the Patient Objective Data Section, a list of clinically relevant patient data is recorded by a user at the time of the patient's admission and at the time of patient's discharge from the hospital. The user is provided two fields to input data, a first field corresponding to the patient's data at the time of admission, and a second field corresponding to the patient's data at the time of discharge. The Patient Objective Data Section includes at least one of the following clinically relevant patient data: weight, I/O, hemoglobin levels, sodium levels, potassium levels, BUN levels, Creatinine levels, BNP levels, Chest X-ray congestion presence (Yes or NO), and Impedance.

An exemplary follow-up form 400 is completed at least one time after the patient is discharged from the hospital. In an embodiment, the follow-up form 400 is completed within 24-72 hours after the patient is discharged. In a further embodiment, a second follow-up form 400 is completed 30-days after the patient is discharged. In another embodiment, a third follow-up form 400 is completed 60 days after the patient is discharged. In yet another embodiment, a fourth follow-up form 400 is completed 90 days after the patient is discharged.

In an exemplary embodiment, the follow-up form 400 includes a Medications, a Follow-up Appointment, and Medical Stability Since Discharge, a Signs and Symptoms, and Recent Lab Results sections. The Medications section includes a Discharge Therapy field and a Home Therapy field. The Discharge Therapy field is identical to the “Current Therapy” field in the Neuro-Hormone Therapy section of the attending form 300 discussed above. In an exemplary embodiment, the Discharge Therapy field is automatically populated from the information entered in the Current Therapy field in the Neuro-Hormone Therapy Section of the attending form 300. The user is provided corresponding fields under the Home Therapy to record the medications category and doses being followed by the discharged patient. If the Discharge Therapy recorded in the Neuro-Hormone Therapy field is different from the current Home Therapy prescribed to the discharged patient at the time of the follow-up form 400, the user is provided a field having a list of reasons for changing the medications since the Discharge Therapy. For B-Blockers, the reasons include bradycardia, hypotension, low output, pulmonary, and Other. For ACEi inhibitors, the reasons include cough, hypotension, rash/allergic, worsening renal function, or Other.

In an exemplary embodiment of the Follow-up Appointment section, the user is presented with a series of questions relating to the patient's follow-up appointment with fields to record the patient's answers. The series of questions includes whether the patient knows when is his/her follow-up appointment, what is the appointment date, with whom is the appointment, whether the patient has transportation to the follow-up appointment, and whether home health is following the patient.

In an exemplary embodiment of the Medical Stability Since Discharge section, the user is presented with a series of questions relating to the patient's medical stability since discharge, with fields to record “yes” or “no” answers to the questions. Examples of the questions include whether rescue diuretics used since discharge, any ER or Urgent visits, CHF Clinic visits, Hospital admission, moved to hospice, and death?

An exemplary embodiment of the Signs and Symptoms section includes fields for the user to record physical changes in the patient which have occurred since discharge, such as weight, shortness of breath, increased edema or abdominal bloating, increase fatigue or no energy/tiredness, palpitation or irregular heartbeat, or lightheadedness/dizziness. For weight, the user selects 2-3 pounds overnight or no change since discharge, and records (+/−)kg difference in weight since discharge. For shortness of breath, the user may select from a list of options including shortness of breath at rest, shortness of breath with usual activity, shortness of breath with greater than usual activity, PND, Orthopnea and how many pillows used, no change since discharge, and increased cough. For Increased edema or abdominal bloating, the user may select from a list of options including increased peripheral edema, abdominal bloating, and early satiety. For increased fatigue or no energy/tiredness, the user may select increased since discharge, improved since discharge, and no change since discharge. For palpitation or irregular heartbeat and lightheadness/dizziness, the user may select yes or no for each.

The user inputted data is analyzed by the analysis module 650 and problem social factors 10a and problem clinical data are identified and recorded. When problem social factors 10a or problem clinic data are identified, the analysis module 650 recommends specific corrective actions linked to each identified problem social factor or problem clinical data. In an exemplary embodiment, the analysis module 650 performs an if/then analysis to link problem social factors 10a and problem clinical data with appropriate corrective actions. Examples of problem social factors 10a and appropriate corrective actions are described above in the social factor evaluation and follow-up evaluation.

An exemplary embodiment of the Recent Lab Results section includes fields for the user to record the levels of sodium, potassium, BUN, Creatinine, and Hemoglobin, and the dates on which each lab test was performed.

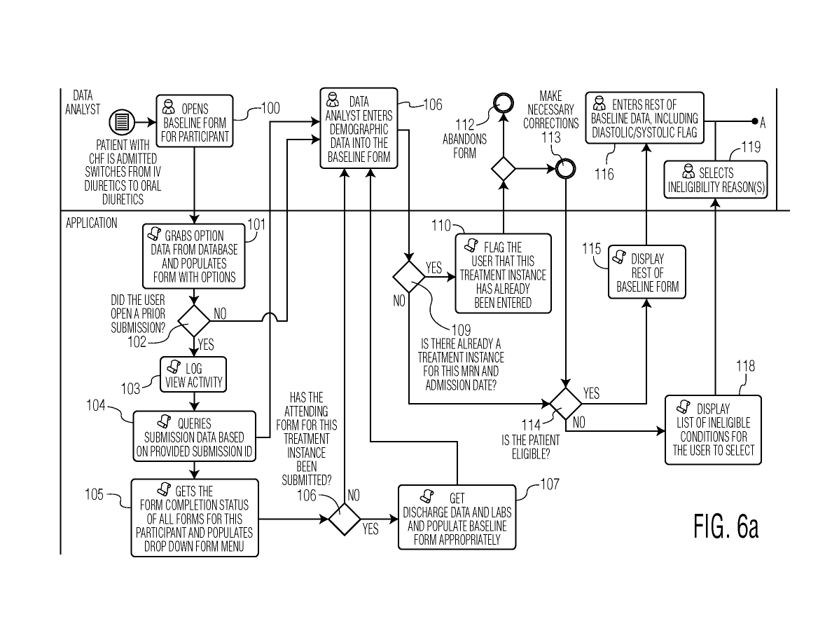

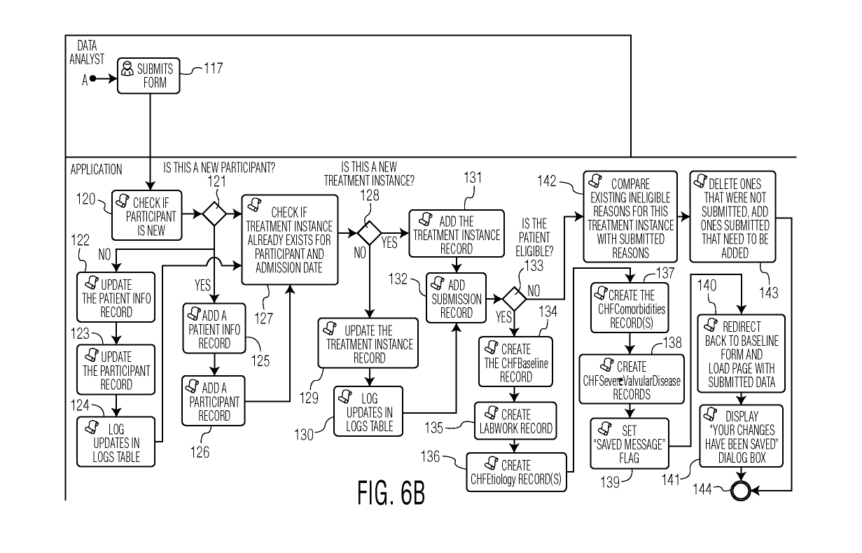

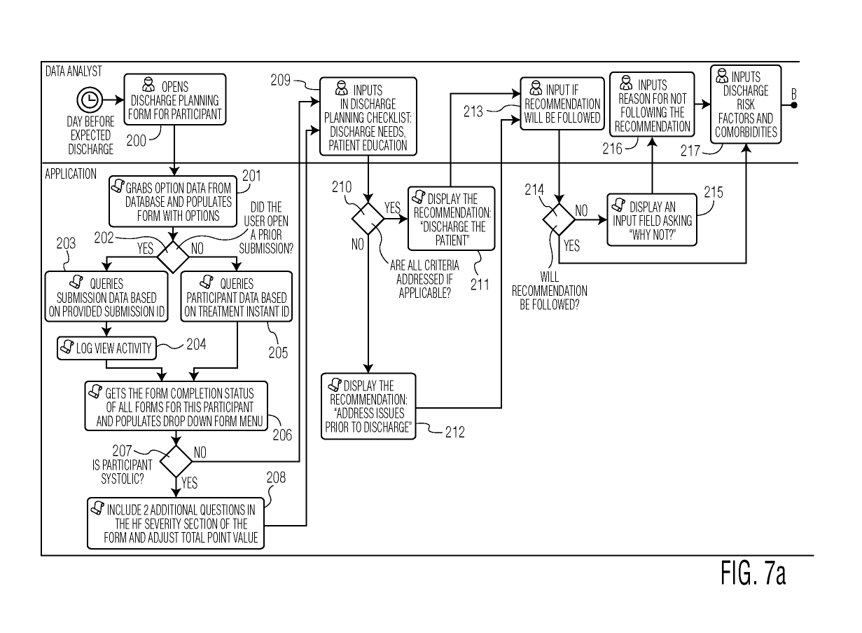

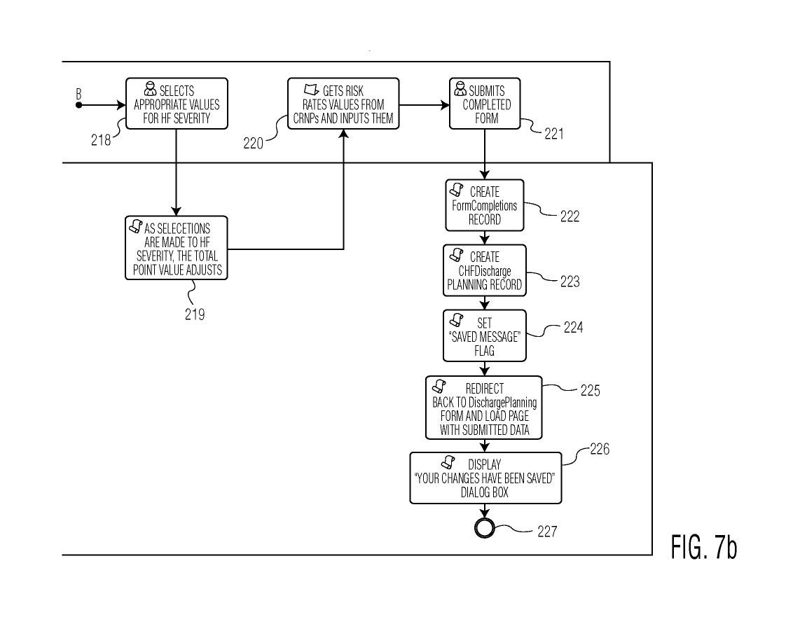

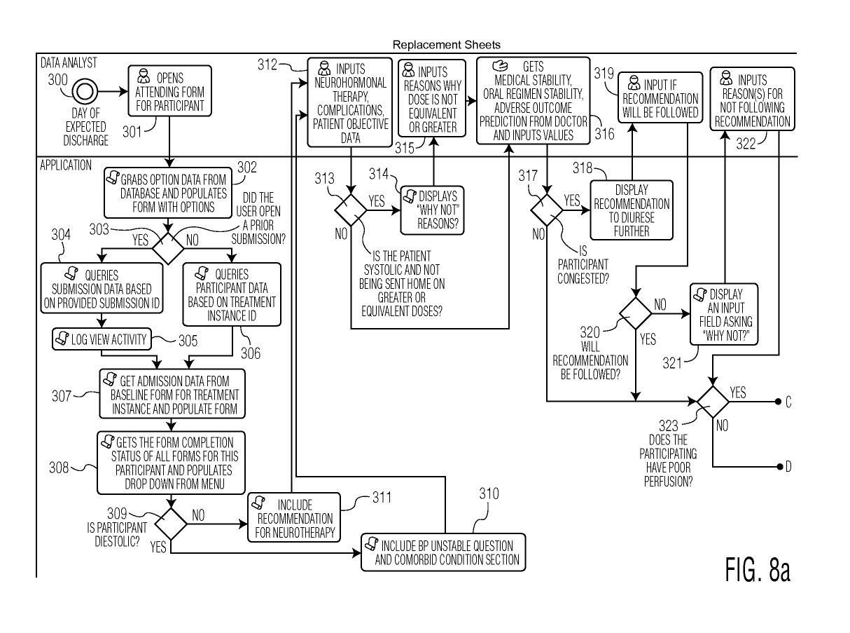

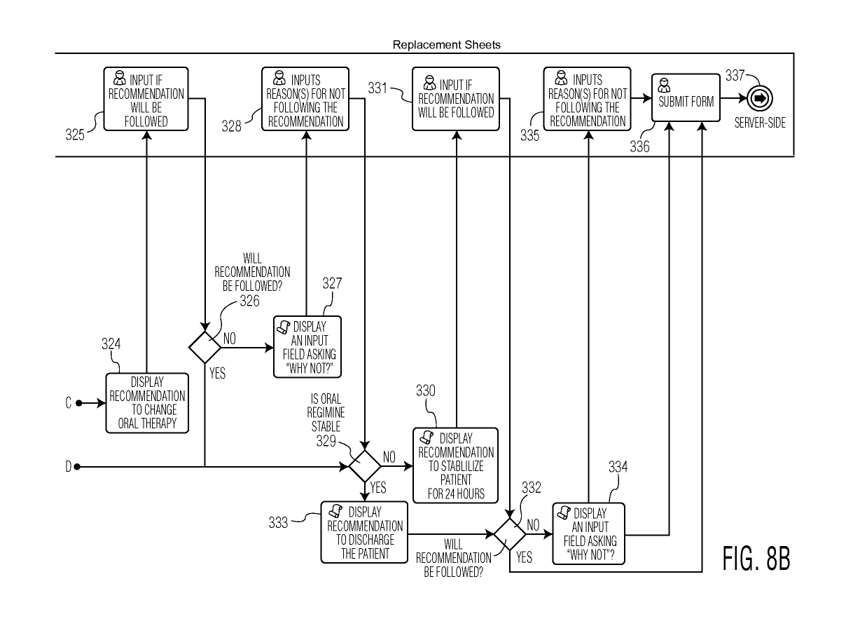

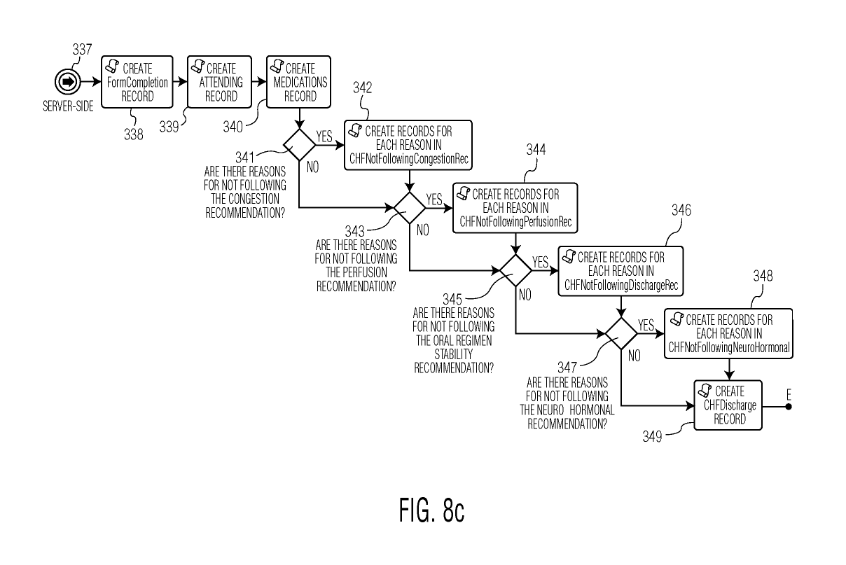

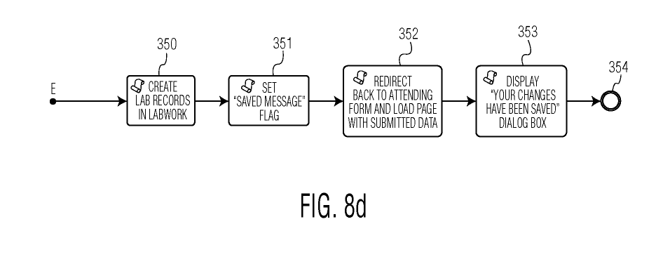

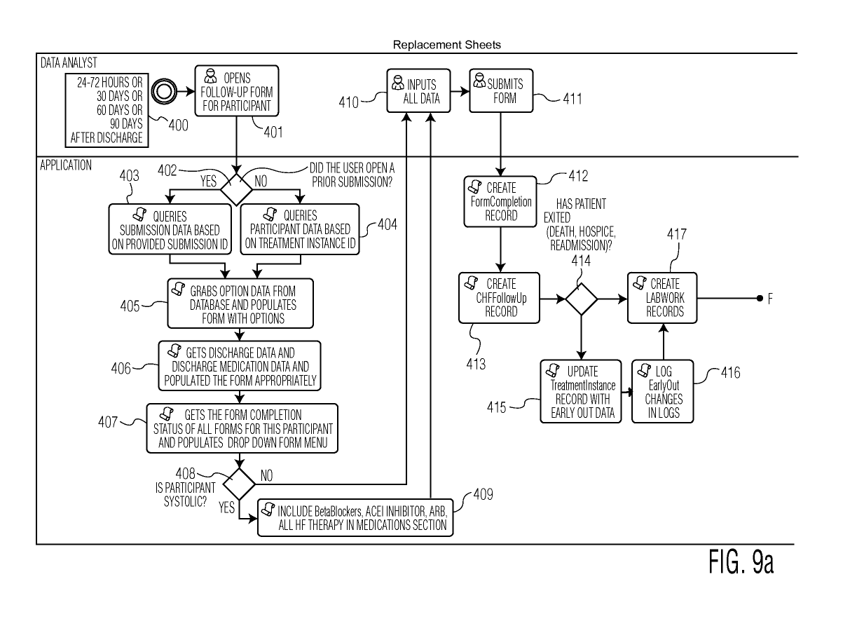

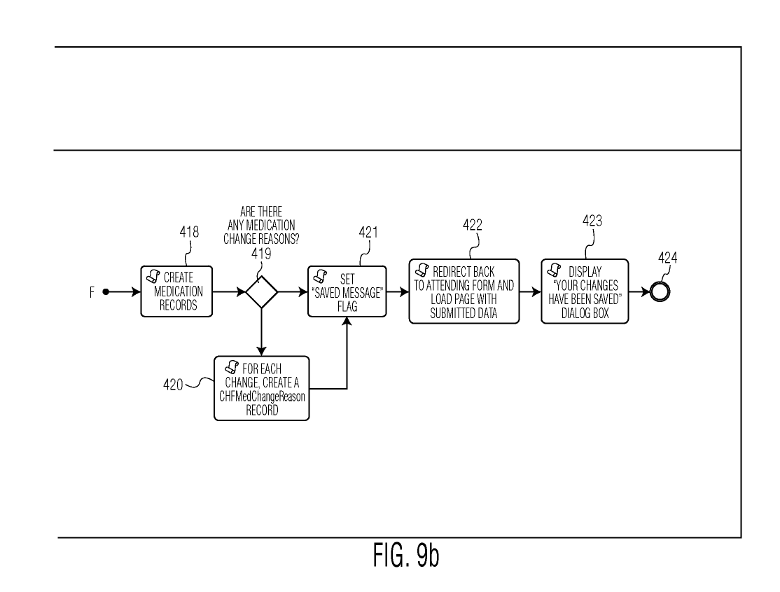

The analysis module 650 provides analytics of the data entered by the user into the application module 640. FIGS. 6-9 show exemplary application logic decision trees performed by the analysis module 650 based on the user inputted data into the application module 640 for each application module form, including the baseline/discharge demographics 100 (FIGS. 6a and 6b), discharge planning 200 (FIGS. 7a and 7b), attending 300 (FIGS. 8a, 8b, 8c, and 8d), and follow-up 400 (FIGS. 9a and 9b) forms.

The exemplary embodiments of application logic decision trees in FIGS. 6-9 are used by the analysis module 650 for a congestive heart failure patient. While this embodiment is in the context of a congestive heart failure patient, one of ordinary skill in the art would appreciate that the application logic decision tree may also be used for patients with other clinic indications.

The exemplary application logic decision tree for the baseline form 100 begins when a patient with congestive heart failure is admitted and switches from IV diuretics to oral diuretics. See FIGS. 6a and 6b. A data analyst (“user”) first opens the baseline form 100 for the patient (“participant”). The analysis module 650 then pulls general data from the database module 630 to auto-populates available general demographic and options information into the baseline form 101. Next, the analysis module 650 determines if the user has opened a prior submitted baseline form 100 or if the user has opened a new baseline form 100 based on whether the user has entered a prior submission ID number 102. If the user has opened a prior submitted baseline form 100, the analysis module 650 logs the user's view activities 103 and then queries submission data based on a user provided submission ID 104. Next, the analysis module 650 determines the form completion status of all the forms having the same treatment ID and populates the baseline form 100 with information entered into the previously submitted baseline 105. The analysis module 650 then determines if an attending form 300 for this treatment instance has been submitted 106. If it has, then the analysis module 650 pulls the discharge data and lab results from the attending form 300 and populates the baseline form appropriately 107. If an attending form 300 has not been submitted, then the user will enter demographic data into the baseline form manually 108. If the user did not open a prior submission, such that the baseline form 100 is new, the user will enter the demographic data into the baseline form manually 108.

The analysis module 650 will then determine if there already is a treatment instance for the user entered medical record number (“MRN”) and admission date 109. If yes, then the analysis module 650 flags the user that this treatment instance has already been entered into the baseline form 110. The user may then abandon the form 112 or make the necessary corrections 113. If the necessary corrections are made 113, then the analysis module 650 determines if the patient is eligible for the patient readmission prevention program 114. If there is not a treatment instance for the user entered MRN, then the analysis module 650 determines if the patient is eligible for the patient readmission prevention program 114.

If the patient is eligible for the patient readmission prevention program, the analysis module 650 instructs the application module 640 to display the rest of the baseline form 115. The user then enters the rest of the baseline data 116, which has been discussed above in reference to the application module 640, and submits the form 117. If the patient is not eligible for the patient readmission prevention program, the analysis module 650 will then instruct the application module 640 to display a list of ineligible conditions for the user to select 118. The user will then select the ineligibility reason(s) that applies 119. The user then submits the form 117.

Next, the analysis module 650 checks the database module 630 to determine if the participant is new 120, 121. If the participant is new, then a patient information record is created 125 and a participant record is created 125. The analysis module 650 then checks the database module 630 to determine if a treatment instance already exists for the participant and admission date 127. If the participant is not new 120,121, the patient information record and participant record are updated 122,123, and the updates are logged into a logs table 124. The analysis module 650 then would check the database module 630 to determine if a treatment instance already exists for the participant and admission date 127.

The analysis module 650 then determines whether this treatment instance is new 128. If the treatment instance is new, then treatment instance is added to the treatment instance record 131 and the submission record 132. If the treatment instance is not new, then the treatment instance record is updated 128, the log updated in the logs table 130, and then the updates 129,130 are added to the submission record 132.

Next, the analysis module 650 analyses the information in the submission record 132 to determine if the patient is still eligible for the patient readmission prevention program 133. If the patient is not eligible 133, then the existing ineligibility reasons for this treatment instance are compared with the submitted reasons 142. Unsubmitted reasons are deleted, and submitted reasons display on the baseline form 100 to user the necessary treatment instance reasons needed for the patient to be eligible 143. The analytical module's application logic decision tree then terminates 144. If the patient is eligible 133, a baseline record 134, Lab work record 135, etiology record 136, co-morbidities record 137, and a severe valvular disease record 138 are created onto the baseline form 100. A “saved” message flag 139 is recorded, and then the baseline form 100 will display the submitted data 140 and the application module 640 will be instructed to display a “Your changes have been saved” dialogue box to the user 141. The analytical module's application logic decision tree then terminates 144

The exemplary application logic decision tree for the discharge planning form 200 discussed above begins when a congestive heart failure patient is going to be discharged. See FIGS. 7a and 7b. A data analyst (“user”) first opens the discharge planning form 200 for the patient (“participant”) 200. The analysis module 650 then pulls option data from the database module 630 to auto-populates available the form with the available options 201. Next, the analysis module 650 determines if the user has opened a prior submitted discharge planning form 202 or if the user has opened a new discharge planning form 200 based on whether the user has entered a prior submission ID number 203. If the user has opened a prior submitted baseline form 100, and the analysis module 650 queries submission data based on a user under the provided submission ID 203. The analysis module 650 then logs the user's view activities 204. Finally, the analysis module 650 pulls from the database module 630 the form completion status of all forms for the participant's treatment and populates the drop down menu in the application module 640 with the pulled information from all the forms 206. If the user has not opened a prior submission, the analysis module 650 uses the participant's treatment instance ID to query the database module 630 for data on the participant 205. The analysis module 650 then completes step 206.

Next, the analysis module 650 determines if the participant is systolic 207. If yes, then two additional questions are automatically populated in the HF Severity section (discussed above) of the form, and the total point value is appropriately adjusted 208, and the user performs step 209. If no, then step 208 is skipped and the user performs step 209.

In another embodiment, the analysis module 650 determines if the participant is diastolic. If yes, then two additional questions are automatically populated in the HF Severity section (discussed above) of the form, and the total point value is appropriately adjusted 208, and the user performs step 209. If no, then step 208 is skipped and the user performs step 209.

In step 209, the user inputs data into the discharge planning checklist, including the discharge needs and patient education subsections. Next, the analysis module 650 determines whether all criteria has been addressed 210. If yes, then the analysis module 650 instructs the application module 640 to display the recommendation “Discharge the patient” 211. If no, then the analysis module 650 instructs the application module 640 to display the recommendation “Address issues prior to discharge” 212. The user then inputs whether the recommendation will be followed 213, 214. If the recommendation will not be followed, the analysis module 650 instructs the application module 640 to display an input field asking “why not” 215. The user then inputs the reason for not following the recommendation 216. The user then inputs the discharge risk factors and co-morbidities 217. If the recommendations will be followed, the user will go directly to step 217. Next, the user selects appropriate values for the HF Severity section 218. As the user makes the selections in the HF Severity section, the analysis module 650 adjusts the total point value 219. The analysis module 650 instructs the application module 640 to display the total point value, and the user inputs rates values from CRNPs and inputs the rates values into the application module 640. Upon input completion, the user submits the complete discharge planning form 221. The analysis module 650 then creates a discharge planning form completion record 222, followed by a discharge planning record 223, and sets a “saved message” flag 224. The analysis module 650 then redirects 222-224 back to the application module 640 to display the discharge planning form 200 containing the submitted data 225 along with a dialog box stating that “your changes have been saved” 226. The analytical module's application logic decision tree terminates 227.

The exemplary application logic decision tree for the attending form 300 discussed above is administered on the day the patient is expected to be discharged 300. See FIGS. 8a, 8b, 8c, and 8d. A data analyst (“user”) first opens the attending form 300 for the patient (“participant”). The analysis module 650 then pulls general data entered into the above discussed forms used in the patient readmission prevention program from the database module 630 and auto-populates the form with the sections discussed above 302. Next, the analysis module 650 determines if the user has opened a prior submitted attending form 300 or if the user has opened a new attending form 300, based on whether the user has entered a prior submission ID number 303. If the user has opened a prior submitted baseline form 100, then the analysis module 650 queries submission data based on a user provided submission ID 304, and logs the user's view activities 305. The analysis module 650 then pulls admission data from the baseline form 100 for the treatment instance and populates the attending form 307. If the user has not opened a prior submission 303, then the analysis module 650 queries participant data stored on the database module 630 based on the treatment instance ID 306, and then performs step 307. Next, the analysis module 650 pulls from the database module 630 the form completion status of all form for the participant and populates the drop down menu in the application module 640 with the pulled information from all the forms 308. Finally, the analytic module determines if the participant is diastolic. If no, the application module 640 is instructed to recommend neurotherapy 311. If yes, then the application module 640 is instructed to display the BP unstable questions and co-morbidity sections 310.

The user then inputs data into the neuro-hormonal therapy, complications, and patient objective data subsections 312. The analytic module then uses the inputted data to determine if the patient is systolic and not being sent home on greater or equivalent doses 313. In another embodiment, the analytic module then uses the inputted data to determine if the patient is diastolic and not being sent home on greater or equivalent does 313. If yes, the application module 640 is instructed to display “why not” reasons 314, and the user inputs the reasons why the dose is not equivalent or greater 315. The user then inputs values for the medical stability, oral regimen stability, and adverse outcome prediction sections 316. If the patient is not systolic 313, then the user goes directly to step 316. In another embodiment, if the patient is not diastolic, then the user goes directly to step 316.

The analytic module then uses the values inputted in step 316 to determine whether the patient is congested 317. If the patient is not congested, the analytic module determines if the participant has poor perfusion 323. If the patient is congested, the analytic module instructs the application to display the recommendation to diurese further 318. The user then inputs whether the recommendation will be followed 319. If the recommendation will be followed 320, then the analytic module determines if the participant has poor perfusion 323. If the recommendation will not be followed 320, then the analytic module instructs the application module 640 to display an input field asking the user “why not” 321. The user then inputs the reason(s) for not following the recommendation 322. The analytic module then determines if the participant has poor perfusion 323.

If the participant does not have poor perfusion, then the analytic module determines if the oral regimen is stable 329. If the participant does have poor perfusion, 323, then the analytic module instructs the application module 640 to display the recommendation to change oral therapy 324. The user then inputs if the recommendation will be followed 325. If the recommendation will be followed 326, then the analytic module determines if the oral regimen is stable 329. If the recommendation is not followed 326, then the analytic module instructions the application module 640 to display an input field asking the user “why not” 327. The user then inputs reason(s) for not following the recommendation 328. The analytic module then determines if the oral regimen is stable 329.

If the oral regimen is stable 329, then the analytical module instructs the application module 640 to recommend the patient be discharged 333. If the recommendation will be followed 332, then the user will submit the form 336. If the oral regimen is not stable 329, then the analytic module instructs the application to display the recommendation to stabilize the patient for 24 hours 330. The user then inputs if the recommendation will be followed 331. If the recommendation will be followed 332, then the user will submit the form 336. If the recommendation will not be followed 332, then the analytic module instructs the application to display an input field asking “why not” 334. The user then inputs the reason(s) for not following the recommendation 335, and then submits the form 336.

Once the attending form 300 has been submitted 336, the analytic module creates a form completion record 338, and attending record 339, and a medications record 340. Next, the analytic module determines if reasons have been inputted by the user for not following the congestion recommendations 341. If not, the analytic module then determines if there are reasons inputted by the user for not following the perfusion recommendation 343. If there are reasons inputted by the user for not following the congestion recommendation 341, records are created for each reason 342. The analytic module then determines if there are reasons inputted by the user for not following the perfusion recommendation 343. If no reasons have been inputted by the user, the analytic module determines if there are any reasons inputted by the user for not following the oral regimen stability recommendation 345. If reasons have been inputted by the user for not following the perfusion recommendations 343, records are created for each reason 344. The analytical module then determines if there are any reasons inputted by the user for not following the oral regimen stability recommendation 345. If reasons have not been inputted by the user, the analytic module then determines if any reasons have been inputted by the user for not following the neuro-hormonal recommendation 347. If the user has inputted reasons for not following the neuro-hormonal recommendations 347, records are created for each reason 348. The analytic module then creates a patient discharge record 349. If the user has not inputted any reasons for not following the neuro-hormonal recommendations 347, the analytical model creates a patient discharge record 349.

The analytical module then creates lab records 350, sets a “saved message” flag 351, and instructs the application module 640 to display the attending form 300 with the submitted data 352 and to display a “your changes have been saved” dialog box to the user 353. The analysis module's 650 application logic decision tree then terminates 354.

The exemplary application logic decision tree for the follow-up form 400 discussed above begins 24-72 hours, or 30 days, or 60 days, or 90 days after a congestive heart failure patient has been discharged 400. See FIGS. 9a and 9b. A data analyst (“user”) first opens the follow-up form 400 for the patient (“participant”). Next, the analysis module 650 determines if the user has opened a prior submitted follow-up form 402. If the user has opened a prior submitted follow-up form 400, the analysis module 650 queries submission data based on a user provided submission ID 403. The analysis module 650 then pulls option data from the database module 630 and instructs the application module 640 to auto-populate the follow-up form 400 with the form's content 405. If the user has not opened a prior submitted follow-up form 400, the analysis module 650 queries the participant data in the database module 630 based on the user entered treatment instance ID 404. The analysis module 650 then performs step 405. Next, the analysis module 650 pulls from the database module 630 the inputted data from the discharge form and discharge medication data, and instructs the application module 640 to auto-populate the follow-up form 400 with the inputted data 406. The analysis module 650 also determines the status of all of the patient readmission prevention forms discussed above and relating to this participant, and instructs the application module 640 to auto-populate the follow-up form's 400 drop down form menu 407.

Next, the analysis module 650 determines if the participant is systolic 408. If the participant is not systolic, then the user is inputs all the data requested on the follow-up form 410. If the participant is systolic 408, the analysis module 650 includes the dosage information for B-Blockers, ACEi inhibitors, ARB, and alternative HF therapy medications in the follow-up form 409, before the user inputs all the data requested on the follow-up form 410.

In another embodiment, the analysis module 650 determines if the participant is diastolic. If the participant is not diastolic, then the user is inputs all the data requested on the follow-up form 410. If the participant is diastolic 408, the analysis module 650 includes the dosage information for B-Blockers, ACEi inhibitors, ARB, and alternative HF therapy medications in the follow-up form 409, before the user inputs all the data requested on the follow-up form 410.

Once the user inputs all the data 410, the user submits the form 411. The analysis module 650 then creates a form completion record 412, and a follow-up form creation record 413. The analysis module 650 then determines if the patient has exited the patient readmission prevention program due to changes in circumstances such as death, hospice, or readmission 414. If the patient has exited, the analysis module 650 updates the treatment instance record with the early out data 415, creates a log of the early out changes in the Logs 416, creates lab work records 417 and medication records 418. If the patient has not exited, the analysis module 650 immediately creates the lab work records 417 and medication records 418.

The analysis module 650 next determines if the user has provided any medication change reasons 419. If the user has provided medication change reasons, a medication change reason record is created for each change 420, and a “saved message” flag 421 is set. If there are no medication change reasons, a “saved message” flag is set immediately 421. The analysis module 650 then instructs the application module 640 to display the follow-up form 400 having the user submitted data 422, and to display a message saying “your changes have been saved” dialogue box 423. The analysis module 650's application logic decision tree then terminates 424.

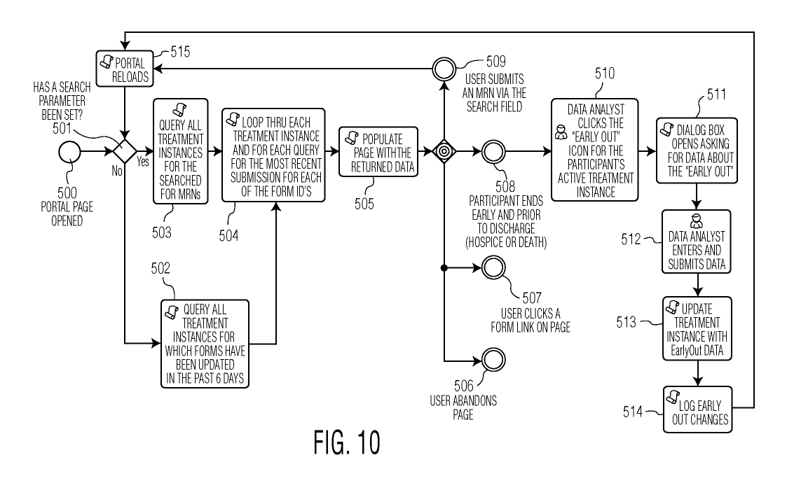

When the user opens the application module 640, a portal page is displayed on the input/output module 500. See FIG. 10. The application module 640 then communicates with the analysis module 650 whether the user has inputted a search parameter 501. If a search parameter has been sent, the analysis module 650 queries all treatment instances for the searched MRN #503. The analysis module 650 then loops through each treatment instance and each query for the most recent submission for each of the above discussed forms 504. If a search parameter has not been sent, the analysis module 650 queries all treatment instances for which of the above discussed forms have been update in the past 6 days 502, before performing step 504. The analysis module 650 then instructs the application module 640 to populate the portal page with the returned data 505. The portal page terminates if the user clicks on a form link on the portal page 507, or if the user abandons the page 506. If the user submits a MRN # in the search field 509, the portal page reloads 515, and the application module 640 returns to step 501, and the above discussed process is repeated. If the search parameter is for participant that has ended the patient readmission prevention program early and prior to discharge 508, the user is prompted to select the “early out” option on the portal page for the participant's active treatment instance 510. The analysis module 650 instructs the application to open a dialog box prompting the user to input data about the “early out” 511. The user inputs the data and submits the answer 512. the analysis module 650 updates the treatment instance with the early out data 513, and logs the early out changes 514. The portal page then reloads 515, and the application module 640 returns to step 501, and the above discussed process will be repeated.

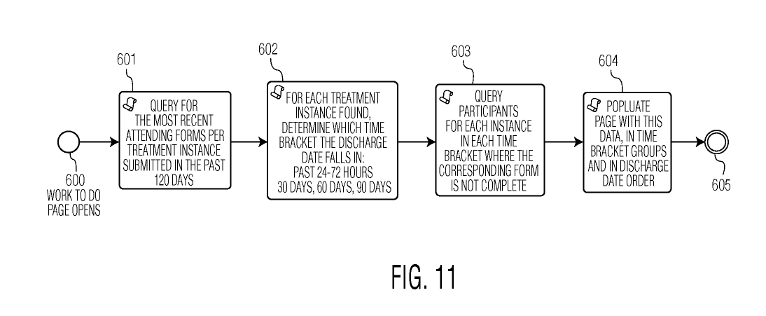

In an exemplary embodiment of a work-to-do application logic decision tree, a work to do page is opened in the application module 640 600. See FIG. 11. The application form instructs the analysis module 650 to run a query for the most recent attending forms 300 per treatment instance submitted in the past 120 days 601. For each treatment instance found, the analysis module 650 determines which time bracket the discharge date falls in past 24-72 hours, 30 days, 60 days, or 90 days time bracket 602. The analysis module 650 then queries participants for each treatment instance in each time bracket where the corresponding form is not complete 603. The analysis module 650 then instructs the application module 640 to populate the work to do page with the queried data, in time bracket groups and in discharge date order 604. The analysis module 650 then terminates the work-to-do application logic decision tree 605.

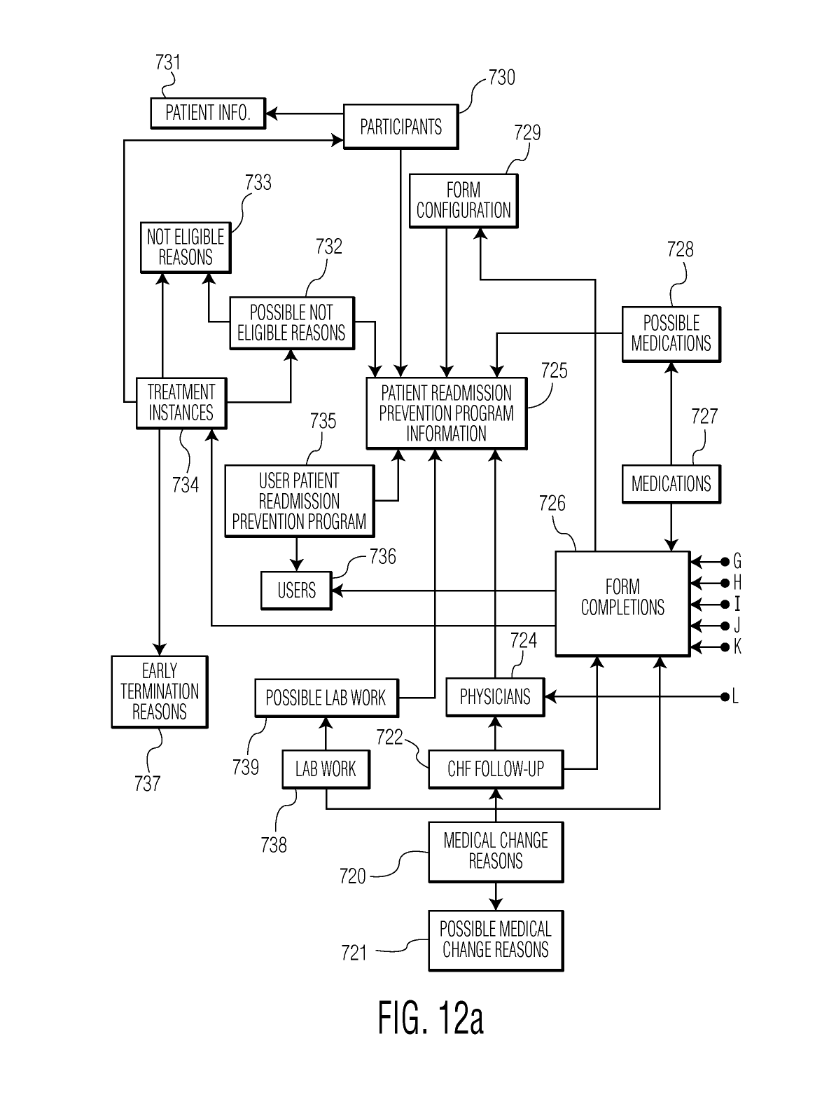

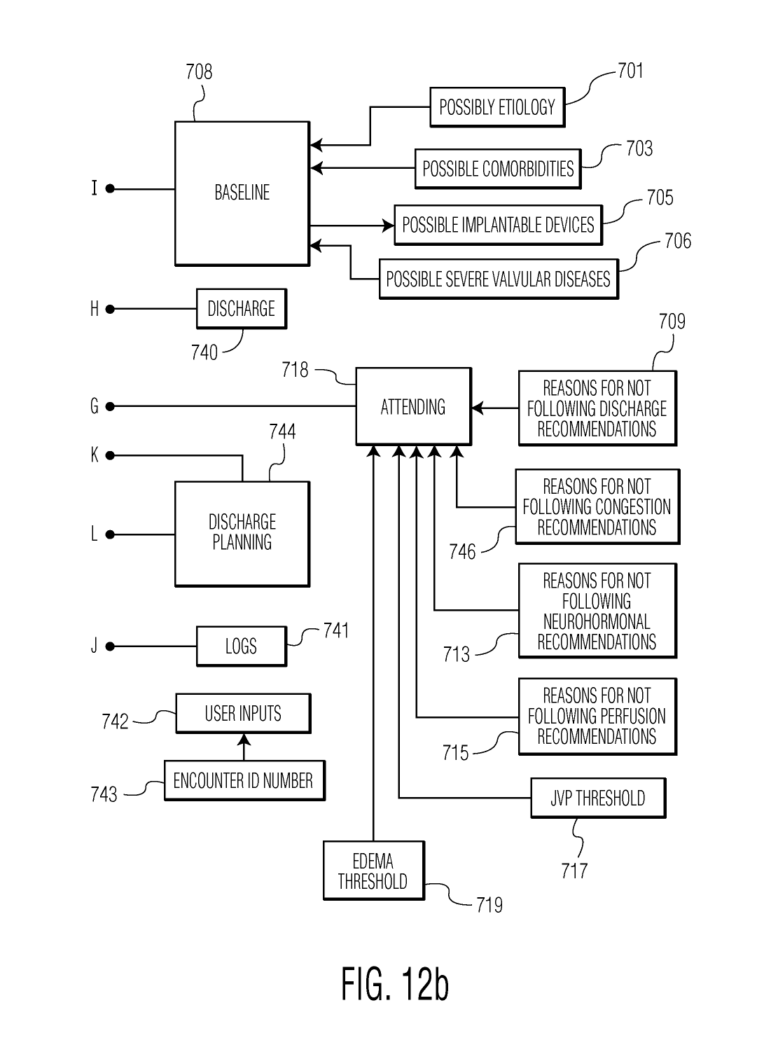

FIGS. 12a and 12b show an exemplary database module method for the patient readmission prevention program. Using a congestive heart failure (“CHF”) participant as an example, when a user opens a CHF baseline form 100 in the application module 640, the database module 630 receives user inputs in database forms corresponding to the selectable options presented in the sections and sub-sections of the baseline form 100. Exemplary user inputs include answers inputted for the questions under Possible Etiology 701, Possible Co-morbidities 703, Possible Implantable Devices 705, and Possible Severe Valvular Diseases 706. The database automatically assigns a single encounter ID number for all of the user inputs 701,703,705,706. All of the user inputs 701,703,705,706 with the same encounter ID number are stored in a corresponding database table 708.

When a user opens an exemplary CHF discharge planning form 200 in the application module 640, the database module 630 receives user inputs in database forms corresponding to the selectable options presented in the sections and sub-sections of the discharge planning form 200. A corresponding discharge planning database table 744 is created and all of the selectable options are stored as “yes” inputs. The user inputs are inputted by the user 742, and the database automatically assigns a single encounter ID number 743 for all of user inputs 742. All of the user inputs 742 with the same encounter ID number are stored in the corresponding database table 744.

When a user opens an exemplary CHF attending form 300 in the application module 640, the database module 630 receives user inputs in database forms corresponding to the selectable options presented in the sections and sub-sections of the attending form 300. Exemplary user inputs include answers inputted for possible not following discharge reasons 709, possible not following congestion reasons 746, possible not following neuro-hormonal reasons 713, and possible not following perfusion reasons 715. The database automatically assigns a single encounter ID number for all of the user inputs 709,746,713,715. All of the user inputs 709,746,713,715 with the same encounter ID number are stored in a corresponding attending database table 718. Additionally, the exemplary user inputs include JVP Threshold 717 and Edema Threshold 719 user inputs. The user inputs for the JVP Threshold 717 include medical stable JVP value, effective data, end date, comparison, threshold value and active inputs. The Edema Threshold 719 includes medical stable edema value, effective date, end date, comparison, threshold value, and active inputs. The JVP Threshold 717 and the Edema Threshold 719 are also stored in the corresponding database table 718.

When a user opens an exemplary CHF follow-up form 400 in the application module 640, the database module 630 receives user inputs in database forms corresponding to the selectable option presented in the sections and sub-sections of the follow-up form 400. While not illustrated, exemplary user inputs include answers inputted for the sections and sub-sections of the follow-up form 400. The database automatically assigns a single encounter ID number for all of these user inputs. The database automatically assigns a single encounter ID number for all of the user inputs, such as the medication change reasons 720, and all of the user inputs with the same encounter ID number are stored in a corresponding database table 722. The medication change reasons 720 auto-populates a possible medication change reasons database table 721 that includes the medicine type, reason for the medication change, and if the change is active. User inputted data from the CHF follow-up database table 722 is pulled by a follow-up timeframe database 23 that records the timeframe description.

A form completions database 726 pulls user inputs in the exemplary CHF baseline database table 708, discharge planning database table 744, attending database table 718, follow-up database table 722, as well as information stored on a logs database 741, a discharge database 740, a medications database 727, and a labwork database 738. The logs database 741 includes log ID's generated by the analysis module 650, such as User ID, activity type, submission ID, activity time, before values, and after values. The discharge database 740 includes encounter ID's associated with a submission ID number, date, weight, IO, Chest Congestion, impedance below the reference line, and impedance comments inputted by the user. The medications database 727 stores medication ID numbers, each ID number including a submission ID, Medicine ID, type, does amount, measurement unit, dose frequency, dose frequency unit, and therapy type. The lab work database 738 includes lab work ID numbers that correspond to a specific submission ID, lab test ID, result, measurement unit, test date, and inpatient stage.

A patient readmission prevention program information database 725 stores a unique ID number for a participant, and includes the participant's description, sponsor and date commenced in the program. The database 725 pulls data from a possible medications database 728, a form configuration database 729, a participants database 730, a possibly not eligible reasons database 732, a possible lab work database 739, a physicians database 724, and a User patient readmission prevention program database 735. The possible medications database 728 pulls data from the medications database 727 under a medicine ID, each medicine ID including a medicine name, active, type, measurement unit, and an patient readmission prevention program ID number. The form configuration database 729 pulls data from the form completions database 726, and includes a Form ID and Version which includes a form name, patient readmission prevention program ID, orders in process, and active version. The participants database 730 includes a participant ID which includes the MRN, patient readmission prevention program ID, gender of the participant, and the date the participant ID was entered. The participant's database 730 pulls the MRN information from a patient information database 731, where the MRN includes the last name, first name, middle name, and date of birth of the participant. The participant's database 730 also pulls data from the treatment instance database 734, discussed below. The possibly not eligible reasons database 732 generates a not eligible ID for user inputs detailing a participant's reasons for ineligibility in the patient readmission prevention program. The possible lab work database 739 pulls data from the lab work database 738 under a lab test ID, which includes lab test names, measurement units, active, and the patient readmission prevention program ID number. The physician's database pulls data from the CHF discharge planning database table 744 and the CHF follow-up database table 722 under a Physician ID number, which includes a physician's name and the participant's patient readmission prevention program ID number. The User patient readmission prevention program database 735 pulls data from a user's database 736, under a user ID number and a patient readmission prevention program ID number, and a description of the user's role. The Users database 736 generates a User ID number that is associated to a username.

A treatment instance database 734 pulls data from the form completions database 726 under the instance ID. The data includes the participant ID, instance start date, early termination date, early termination ID number, the eligibility status of participant in the patient readmission prevention program, and the participant's hospital admission date.

A not eligible reasons database 733 pulls data associated with the not eligible ID from the possible not eligible reasons database 732, and data associated with the Instance ID from the treatment instance database 734.

An early termination reasons database 737 pulls data from the treatment instance database 734, and stores an early termination ID number, which corresponds to a termination description.

The foregoing illustrates some of the possibilities for practicing the invention. Many other embodiments are possible within the scope and spirit of the invention. It is intended that the foregoing description be regarded as illustrative rather than limiting, and that the scope of the invention is given by the appended claims together with their full range of equivalents.

Further, while the exemplary embodiments discussed above are in the context of congestive heart failure patients, one of ordinary skill in the art would appreciate that the general method for reducing preventable hospital readmissions 1 and the predictive patient readmission system 200 have general applicability across therapeutic areas.

1. (canceled)

2. A social factor evaluation system for reducing hospital readmissions of discharged patients, comprising:
an input output module;
a processor connected to the input output module;
a database module connected to the processor, storing a navigable social factors evaluation accessible through the input output module by a user, and receiving social factors evaluation data inputted by the user through the input output module;
an application module connected to the processor and database module, and providing a visual display of the social factors evaluation on the input output module; and
an analysis module connected to the database module and the application module, and performing analytics of the inputted data.

3. The social factor evaluation system of claim 2, wherein the social factors evaluation includes data relating to a patients access to physical assessment devices, medication acquisition and administration, financial literacy, health literacy, nutrition, activities of daily living and home situation, access to transportation, or any combination thereof.

4. The social factor evaluation system of claim 2, wherein the social factors evaluation is integrated into an electronic medical record system having a patient's clinical data.

5. The social factor evaluation system of claim 2, wherein the analysis module identifies problem social factors from the inputted data.

6. The social factor evaluation system of claim 5, wherein the analysis module instructs the application module to display a list of the identified problem social factors on the input-output module.

7. The social factor evaluation system of claim 5, wherein the analysis module determines corrective actions that address the identified problem social factors.

8. The social factor evaluation system of claim 7, wherein the analysis module instructs the application module to display a list of the corrective actions on the input output module.

9. A process of performing a social factor evaluation for reducing hospital readmissions of discharged patients, comprising the steps of:
administering a social factors evaluation on an admitted patient;
inputting data from the social factors evaluation into an input-output module;
identifying problem social factors through an analysis module;
displaying suggested corrective actions on the input-output module;
performing corrective actions prior to the patient's discharge.

10. The process of performing a social factor evaluation of claim 9, further comprising the step of generating a patient discharge plan based on the social factors evaluation.

11. The process of performing a social factor evaluation of claim 10, further comprising the step of administering a follow-up evaluation on a discharged patient.

12. The process of performing a social factor evaluation of claim 11, wherein the follow-up evaluation determines a level of compliance by the discharged patient with the patient discharge plan.

13. The process of performing a social factor evaluation of claim 9, wherein the social factors evaluation includes data relating to a patients access to physical assessment devices, medication acquisition and administration, financial literacy, health literacy, nutrition, activities of daily living and home situation, access to transportation, or any combination thereof.

14. The process of performing a social factor evaluation of claim 9, wherein the social factor evaluation is integrated into a medical health record system.

15. The process of performing a social factor evaluation of claim 14, further comprising a step of administering an evaluation having a combination of patient clinical data from the medical health record system and the social factor evaluation.

16. The process of performing a social factor evaluation of claim 15, further comprising the step of identifying problem patient clinical factors in combination with the problem social factors.

17. The process of performing a social factor evaluation of claim 16, further comprising the step of performing corrective clinic actions prior to the patient's discharge.
